(19) United States
(12) Patent Application Publication
(10) Pub. No.: US 2026/0236965 A1
(43) Pub. Date: Aug. 13, 2026

(54) Using Machine Learning to Power a Brand Integrity Platform

(71) Applicant: Vericrypt, Inc., New York, NY (US)

(72) Inventors: Tamara Zubatiy, Chattanooga, TN (US); Divya Palaniswamy, Rockville, MD (US); Grant Nelson, Chattanooga, TN (US)

(21) Appl. No.: 19/147,959

(22) PCT Filed: Mar. 12, 2024
(86) PCT No.: PCT/US2024/019584

§ 371 Date: Jul. 14, 2025

Related U.S. Application Data
(60) Provisional application No. 63/490,178, filed on Mar. 14, 2023.

(51) Int. Cl. G06Q 30/02; H04L 9/40

(52) U.S. Cl. CPC G06Q 30/0278; H04L 63/0428

(57) ABSTRACT

Transcribed text associated with a predetermined source is accessed by a brand integrity platform. Features of the transcribed text are input into a classifier that is configured to detect presence of sensitive content of a predetermined category in the input features. The features are input into a tonal model that is trained to detect a neutral emotion score. A plurality of neutral score thresholds associated with the predetermined category of sensitive content whose presence is detected in the input features are accessed. The accessed plurality of neutral score thresholds are applied to the detected neutral emotion score to determine, for the predetermined source, a risk level associated with the predetermined category of sensitive content. An action is performed when the risk level for the predetermined category of sensitive content for the predetermined source meets a tolerance threshold associated with a user.

### CROSS-REFERENCE TO RELATED APPLICATION

This application claims the benefit of U.S. Provisional Application Ser. No. 63/490,178, filed Mar. 14, 2023, the entire content of which is incorporated by reference herein.

### TECHNICAL FIELD

This disclosure relates to providing digital items, and, more specifically, to analyzing content for real-time valuing of the digital items.

### BACKGROUND

In display and cable television, most of the digital item placements are done using real time value determination on an open exchange. To power this, all digital item inventory for each publisher (e.g., content creator) must be analyzed and the outputs made available to digital item providers for targeting. A digital item inventory is a collection of one or more digital item spaces on web pages (e.g., banner advertisements), TV shows or podcasts (e.g., advertisement time slots), and the like. In podcasts, less than 2% of digital items are placed using real time valuing on an open exchange and most digital items are placed directly. Regardless of the medium, given the sheer volume of content available to digital item providers to choose from, it becomes difficult to manually determine whether the content where a digital item is being placed conforms to the digital item provider's values. A better, more automated approach is desirable.

### SUMMARY

In one embodiment, a method, system, and computer-readable medium include a plurality of steps or components. The steps include a step of accessing transcribed text associated with a predetermined source, and a step of inputting features of the transcribed text into a classifier that detects presence of a predetermined category of sensitive content in the input features. The steps further include a step of inputting the features into a tonal model which is trained to detect a neutral emotion score, and a step of accessing a plurality of neutral score thresholds associated with the predetermined category of sensitive content whose presence is detected in the input features. Still further, the steps include a step of applying the accessed plurality of neutral score thresholds to the detected neutral emotion score to determine for the predetermined source a risk level associated with the predetermined category of sensitive content, and a step of performing an action in response to determining that the risk level for the predetermined category of sensitive content for the predetermined source meets a tolerance threshold associated with a user.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a system environment, according to some embodiments.

FIG. 2 is a block diagram of a brand integrity platform of FIG. 1, in accordance with some embodiments.

FIGS. 3 and 4 are example illustrations of graphical user interfaces provided by the brand integrity platform for advertisers analyzing content for determining ad placements, in accordance with some embodiments.

FIG. 5 is a flow chart illustrating a process for determining a risk level for content, in accordance with some embodiments.

FIG. 6 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

This disclosure pertains to a transparent, automated platform and process for contextualizing content (e.g., website content (e.g., webpages, blogs), audio content (e.g., podcasts, music), video content (e.g., streaming shows, TV shows, movies) generated by publishers. Techniques disclosed herein look to access content from different publishers, convert the content into text, and perform an analysis process to match digital item providers with relevant, safe and suitable content and with content creators.

In some embodiments, contextual content analysis includes analysis for content suitability, host intelligence (e.g., public sentiment), and contextual targeting. Content suitability may consider (standardized and/or custom-defined) categories of topics being discussed and tonal qualities of the discussion/mentions. The brand integrity platform may enable users (e.g., advertisers looking to place ad buys in association with content and/or content creators) to identify the categories that are of interest for the brand being advertised and the acceptable level of risk associated with the identified category. For example, the categories may be the global alliance for responsible media (GARM) standardized component categories. The brand integrity platform makes it possible to characterize at scale the discussion of the categories and determine a risk level associated with each category (e.g., whether the discussion is informative, dramatic, or glamorizing the category or topic), and thus, identify for each advertiser, content that matches the acceptable level of risk for associated with each identified category for that advertiser. In some embodiments, the brand integrity platform may utilize custom-built machine learning models for each of the identified categories. The brand integrity platform may further provide transparency into the outputs by specifically highlighting the utterance or mention in the content that resulted in a corresponding risk level.

In some embodiments, the brand integrity platform further performs public sentiment analysis based on publicly available information (e.g., live news feeds) for content creators associated with the content identified as matching the preferences of a particular advertiser to thereby provide additional actionable signals (e.g., a timeline showing positive, neutral or negative public sentiment scores) to advertisers about where to advertise and what content and/or content creators to avoid.

In some embodiments, the brand integrity platform may further include contextual targeting features to identify and aggregate topics that appear repeatedly in particular content at, e.g., an episode-level, or a show-level, and identify corresponding matching topics from a standardized taxonomy (e.g., Interactive Advertising Bureau (IAB) content categories). The taxonomy categories may be presented to the advertiser as an additional datapoint at a selected level of granularity (e.g., episode-level, show-level) for the identified content. As a result of the contextual targeting features, the brand integrity platform can provide transparency about the context of the content. Such transparency may be more granular than the content's “genre”, and thus allow for dynamic targeting at, e.g., the episode-level.

### Example System Environment

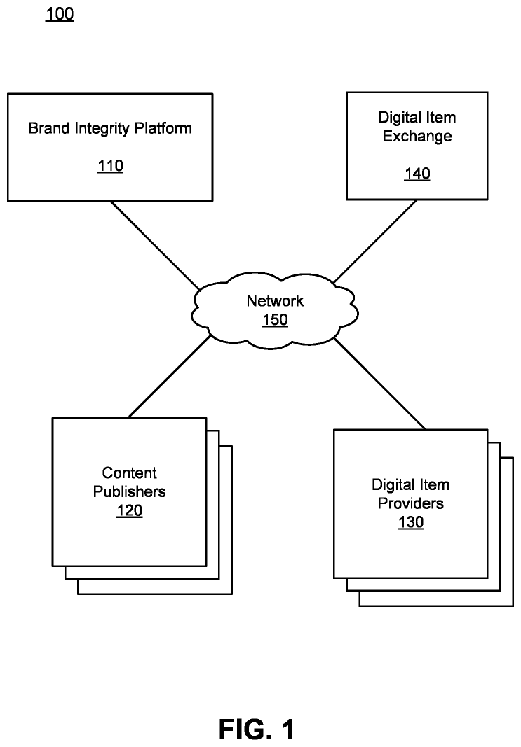

FIG. 1 illustrates a system environment 100, according to some embodiments. The environment 100 of FIG. 1 includes a brand integrity platform 110, publishers 120, digital item providers 130 (e.g., advertisers or other providers of different types of digital items), and digital item exchange 140 (e.g., such as an advertisement (“ad”) exchange or one or more ad servers), each communicatively coupled via a network 150. It should be noted that in other embodiments, the environment 100 may include different, fewer, or additional components than those illustrated in FIG. 1.

The brand integrity platform 110 may include one or more computing servers that perform various tasks related to providing brand integrity services to advertisers. The various tasks may include providing a frontend software platform (e.g., a software-as-a-service SaaS platform for advertisers to set content preferences, view matching content, and select content for ad placements), analyzing content for assigning risk levels under predetermined content categories and contextualizing the content by assigning standardized tags or topics to the content at various levels of granularity, and analyzing publicly available information for content creators associated to the content to generate public sentiment scores for the content creators over time. The tasks may also include taking actions on behalf of the advertiser (e.g., placing bids for ad placement).

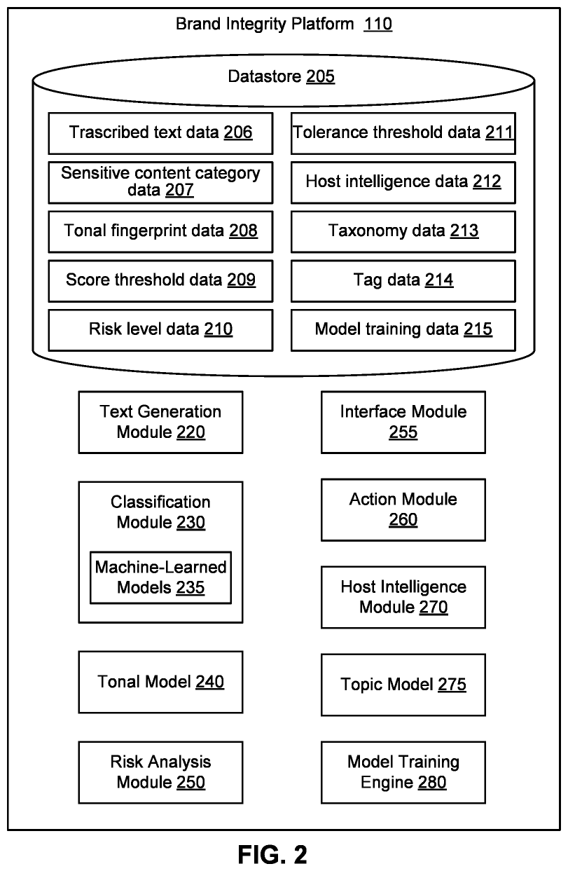

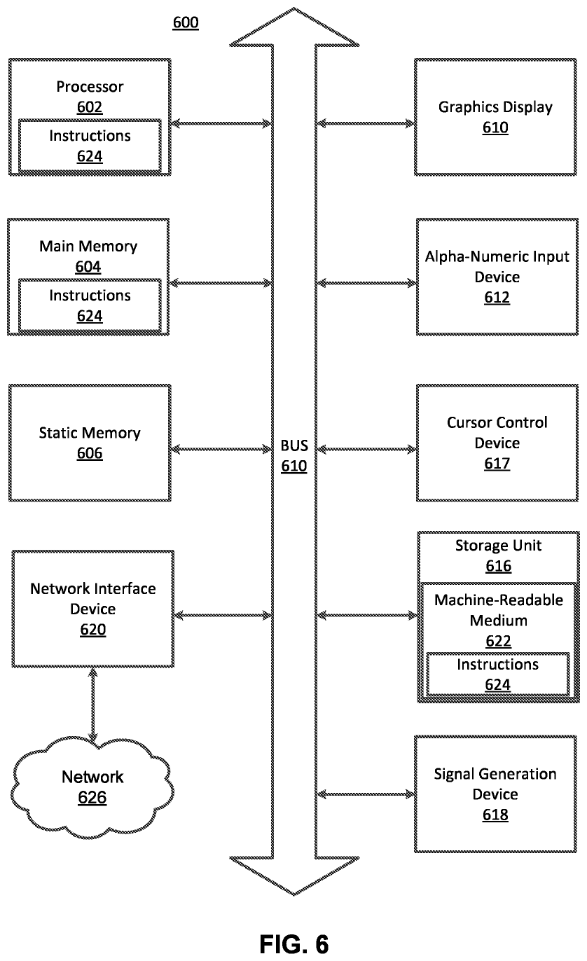

The brand integrity platform 110 may be operated by an entity that uses a combination of hardware and software to build and operate the platform. A computing server used by the brand integrity platform 110 may include some or all example components of a computing machine described in FIG. 6. The brand integrity platform 110 may include a computing server that takes different forms. In some embodiments, the brand integrity platform 110 may be a server computer that executes code instructions to perform various processes described herein. In some embodiments, the brand integrity platform 110 may be a pool of computing devices that may be located at the same geographical location (e.g., a server room) or be distributed geographically (e.g., clouding computing, distributed computing, or in a virtual server network). In some embodiments, the brand integrity platform 110 may be a collection of servers that cooperatively provide content analysis services to advertisers as described. The brand integrity platform 110 may also include one or more virtualization instances such as a container, a virtual machine, a virtual private server, a virtual kernel, or another suitable virtualization instance. The brand integrity platform 110 may provide advertisers 130 with various content analysis services as a form of cloud-based software, such as software as a service (Saas), through the network 150. Examples of components and functionalities of the brand integrity platform 110 are discussed in further detail below with reference to FIG. 2.

Publishers 120 can sell their ad inventories to advertisers 130. Multiple publishers 120 and multiple advertisers 130 can participate in auctions in which selling and buying of ad inventories take place. Auctions can be conducted by an ad network or ad exchange 140 (e.g., one or more ad servers) that brokers between a group of publishers 120 and a group of advertisers 130.

The network 150 provide connections to the components of the brand integrity platform environment 100 through one or more sub-networks, which may include any combination of the local area and/or wide area networks, using both wired and/or wireless communication systems. In some embodiments, the network 150 use standard communications technologies and/or protocols. For example, network 150 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over network 150 may be represented using any suitable format, such as hypertext markup language (HTML), extensible markup language (XML), JavaScript object notation (JSON), structured query language (SQL). In some embodiments, all or some of the communication links of network 150 may be encrypted using any suitable technique or techniques such as secure sockets layer (SSL), transport layer security (TLS), virtual private networks (VPNs), Internet Protocol security (IPsec), etc. The network 150 may also include links and packet switching networks such as the Internet.

### Example Brand Integrity Platform Components

FIG. 2 is a block diagram illustrating various components of an example brand integrity platform 110, in accordance with some embodiments. A brand integrity platform 110 may include a datastore 205, a text generation module 220, a classification module 230, a tonal model 240, a risk analysis module 250, an interface module 255, an action module 260, a host intelligence module 270, a topic model 275, and a model training engine 280.

The datastore 205 may store different types of data utilized, generated, or received by the brand integrity platform 110 for performing the different content analysis and ad placement operations described herein. For example, the datastore 205 may store transcribed text data 206, sensitive content category data 207, tonal fingerprint data 208, score threshold data 209, risk level data 210, tolerance threshold data 211, host intelligence data 212, taxonomy data 213, tag data 214, and model training data 215. The classification module 230 may include a machine-learned model 235. In various embodiments, the brand integrity platform 110 may include fewer or additional components. The brand integrity platform 110 also may include different components. The functions of various components in the brand integrity platform 110 may be distributed in a different manner than described below. Moreover, while each of the components in FIG. 2 may be described in a singular form, the components may present in plurality.

The components of the brand integrity platform 110 may be embodied as software engines that include code (e.g., program code comprised of instructions, machine code, etc.) that is stored on an electronic medium (e.g., memory and/or disk) and executable by a processing system (e.g., one or more processors and/or controllers). The components also could be embodied in hardware, e.g., field-programmable gate arrays (FPGAs) and/or application-specific integrated circuits (ASICs), that may include circuits alone or circuits in combination with firmware and/or software. Each component in FIG. 2 may be a combination of software code instructions and hardware such as one or more processors that execute the code instructions to perform various processes. Each component in FIG. 2 may include all or part of the example structure and configuration of the computing machine described in FIG. 6.

The text generation module 220 is configured to generate transcribed text associated with a predetermined source. As used herein, the predetermined source is any content from a publisher that includes ad inventory and that is analyzed by the brand integrity platform 110. For example, the predetermined source may be text content, audio content, video content, and the like. Text content may refer to textual data sources like a blog post, a website, and the like. Audio content may refer to an audio blog, a podcast, an audio book, music, streaming audio, radio, user generated content, display ads, connected and the like. Video content may refer to video logs, TV shows, movies, mini-series, streaming video, and the like.

The text generation module 220 acquires the content via proprietary IPs or public IPs, processes the content, and transforms it into text data for further processing. The transcribed text generated by the text generation module 220 may correspond to a part or a whole of the predetermined source. For example, in case of a particular podcast, the transcribed text may correspond to the whole show or podcast series, a particular season of the podcast, a particular episode, a particular portion of a particular episode, or one or more sentences in an episode. In some embodiments, a publisher (e.g., podcaster) may upload their audio files to a hosting platform, which may create unique RSS feeds or metadata. The text generation module 220 may store these feeds/metadata in a MySQL database and process the data for text generation. In some embodiments, the text generation module 220 may include translating an audio file from a foreign language to English. For example, a language identification algorithm may be used to detect a predominant language spoken and transcribe using the appropriate language. The text generation module 220 may then translate the text from language of origin to English. A third-party service may be used to transcribe the audio files to text and translate to English. The third party service may use advanced machine learning and speech recognition to provide speech-to-text for both recorded media and real-time streaming by, e.g., providing an API that accepts RSS feeds that are in XML format as input, and returning transcribed/translated data returned from the API in JSON format. The text generation module 220 may store the transcribed/translated text data for the predetermined source (e.g., for each episode of a podcast) as transcribed text data 206 in the datastore 205. For example, the datastore 205 may be a MySQL database on the cloud.

The classification module 230 may access the transcribed text data 206 in the datastore 205 for detecting presence of a predetermined category of sensitive content in the transcribed text data 206. In some embodiments, the classification module 230 may extract features from the transcribed text data 206 and input the features into a classifier to detect the presence of the predetermined category of sensitive content in the input features.

The Global Alliance for Responsible Media (GARM) has developed common definitions on what is harmful and sensitive content via twelve content categories. GARM's standards identify 13 categories to label content, a safety floor to prevent monetization of harmful content, and risk levels to describe acceptable exceptions on sensitive content for brands. GARM's definitions are designed to help advertisers align their brands with the risk levels they consider appropriate. They also provide a baseline for making decisions and scaling media strategies. Some of the GARM categories include standardized categories for adult & explicit sexual content; obscenity and profanity; debated sensitive social issues; illegal drugs tobacco and alcohol; arms and ammunition; and the like.

In some embodiments, the classification module 230 may include one or more classifiers that are configured to detect the presence of topics in the transcribed text data 206 that correspond to one or more of the GARM categories. In other embodiments, an advertiser may define that own customized category of what topics the advertiser considers sensitive content, and in this case, the classification module 230 may be configured to detect the presence of topics in the transcribed text data 206 that correspond to one or more of the advertisers personalized, customized brand safety categories for sensitive content (e.g., natural disaster category, occult category, etc.) The brand safety categories for sensitive content (e.g., GARM categories and corresponding topics, advertiser-specific customized safety categories and corresponding topics) may be saved in the datastore 205 as sensitive content category data 207.

In some embodiments, the classification module 230 may be configured to detect the presence of sensitive content for a given category by using a keyword searching technique. For example, the classification module 230 may include a keyword search engine to compare the text of an input query corresponding to the transcribed text data 206 to the text of each record in a search index that may be defined for one or more of the plurality of content categories for sensitive content that classification module 230 is designed to detect. Every record that matches (whether exact or similar) is returned by the search engine. Most keyword search engines rely on structured data, where the objects in the index are clearly described with single words or simple phrases.

FIG. 2 shows that the classification module 230 includes machine learned models 235. In some embodiments, each machine learned model 235 may be trained by the model training engine 380 based on empirical text samples (e.g., empirical transcribed text data stored as model training data 215) including text samples labeled to indicate presence of the predetermined category of sensitive content and text samples labeled to indicate absence of the predetermined category of sensitive content. Each machine learned model 235 may be trained by the model training engine 380 to detect the presence of one of the predetermined categories of sensitive content. In some embodiments, the machine learned model may be an NLP-based binary classifier that assigns a label or class to input text (e.g., a feature vector representing the text data 206) to categorize whether a comment (e.g., sentence) is, e.g., hate speech or not hate speech, which is one of the GARM sensitive content categories. The machine learned model 235 for detecting hate speech may use transfer learning techniques for implementing binary text classification. There are two existing strategies for applying pre-trained language representation to down-stream tasks in NLP: feature based and fine tuning. In some embodiments, the binary classification based machine learned model is a fine-tuned Bidirectional Encoder Representations from Transformers (BERT) base model (uncased). The training dataset for the BERT-based machine learned model 235 for detecting hate speech may include examples labeled under one of two categories-hate and no hate. Similar techniques may be used to train other machine learned models 235 for detecting other predetermined sensitive content categories (e.g., GARM categories, or user defined custom sensitive content categories).

The tonal model 240 is configured to input the features of the transcribed text and detect a tonal fingerprint. The tonal fingerprint represents one or more expressed emotions in the input features and a predicted probability for each expressed emotion. For example, a neutral emotion score is based on a predicted probability of the input features expressing a neutral emotion.

In some embodiments, the tonal model 240 may be a machine learning model trained by the model training engine 380 based on empirical text samples (e.g., empirical transcribed text data stored as model training data 215) including text samples labeled to indicate presence of one or more of a plurality of human emotions and a labeled score for each, one of the plurality of human emotions being a neutral emotion. The tonal model 240 is configured to detect emotions from the input text features using NLP techniques. The emotions that may be detected by the tonal model 240 for input text include Admiration, Amusement, Anger, Annoyance, Approval, Caring, Confusion, Curiosity, Desire, Disappointment Disapproval, Disgust, Embarrassment, Excitement, Fear, Gratitude, Grief, Joy, Love, Nervousness, Optimism, Pride, Realization, Relief, Remorse, Sadness, Surprise, Neutral emotion, and the like.

In some embodiments, the tonal model 240 may be a pre-trained DistilBERT-base-uncased model for model training. DistilBERT is a smaller version of BERT developed and open-sourced. It is a lighter and faster version of BERT that roughly matches its performance. DistilBERT has 40% less parameters that BERT-based-uncased model, runs 60% faster while preserving over 95% of BERTs performance. The tonal model 240 may output for each of the above identified emotions and based on the input text sample, an emotion score (e.g., neutral emotion score, tonal fingerprint). The output emotion scores (e.g., neutral emotion score, tonal fingerprint) may be utilized downstream in the analysis pipeline to output risk levels for predetermined content based on samples of the content input as transcribed text. The tonal model 240 may also store the output scores may in the datastore as tonal fingerprint data 208.

Based on the tonal fingerprint data 208 (e.g., neutral emotion score) output from the tonal model 240, the risk analysis module 250 may determine for the predetermined source (i.e., the input content such as a podcast episode corresponding to the transcribed text data) a risk level associated with the predetermined category of sensitive content (e.g., GARM's hate speech category).

To determine the risk level for a particular category, the risk analysis module 250 may access predetermined metrics that define rules associated with the tonal fingerprint for determining whether the discussion in a current input sample (e.g., representing a podcast episode) is informative (low risk), dramatic (medium risk) or glamorizing (high risk). The rules may be related to predetermined emotion score threshold cutoffs, tone emotion ratios, and the like. For example, for each of predetermined categories of sensitive content, neutral score thresholds were identified that are specific to the different categories and that define the risk cutoff levels or scores for whether the analyzed sample of content is informative (low risk), dramatic (medium risk) or glamorizing (high risk). For example, podcasts that discuss glamorized content have very low neutral emotion scores compared to dramatic and informative contents. That is, for each of the GARM sensitive content categories, neutral emotion scores vary for each risk level. As another example, podcasts that glamorize murder, violent acts, suicide, addiction, mental illness, and sexual assault have neutral emotion scores that are relatively lower compared to podcasts that talk about or create an Op-Ed on topics of murder, violent acts, suicide, addiction, mental illness and sexual assault. As another example, podcasts that feature informative content like news features on violent acts, suicide, addiction, mental illness and sexual assault have relatively high neutral scores compared to podcasts that feature Op-Ed content. Based on these distinctions, risk cutoff levels or scores for the neutral emotion for each of predetermined sensitive content categories were determined. Then, based on a current output neutral emotion score from the trained tonal model 240, the risk analysis module 250 can determine the risk level for a current input sample of content by, e.g., accessing the neutral score thresholds associated with a particular category of sensitive content whose presence is detected in the input features, and applying the accessed plurality of neutral score thresholds to the detected neutral emotion score to determine for the predetermined source a risk level associated with the predetermined category of sensitive content. As another example, the predetermined metrics may define a rule flagging content with a high risk level for murder (one of the GARM categories) when the tone model 240 detects a high threshold score for happiness, along with a high threshold score for joy and a high threshold score for enthusiasm.

The predetermined metrics that define the rule associated with the tonal fingerprints may be predetermined and stored in the datastore 205 as score threshold data 209. As explained previously, the score threshold data 209 may be predetermined for each category of sensitive content the classification module 230 is designed to detect the presence of for a particular advertiser.

In some embodiments, the risk analysis module 250 outputs the risk levels as low risk, medium risk, or high risk. However, this is not intended to be limiting. In other embodiments, the risk analysis module 250 may assign a risk score or use another similar metric to rate the risk level of content to predetermined categories of sensitive content.

The process performed by the tonal model 240 and the risk analysis module 250 may be repeatedly performed for each sentence, episode, or the whole show of a predetermined source (e.g., a particular TV show, a particular podcast) to determine the risk level for that show (e.g., predetermined source) at different levels of granularity. Moreover, as more content (e.g., new episodes are released) the risk analysis module 250 may repeatedly analyze the new content to update the risk level for the content. That is, the risk analysis module 250 may periodically redetermine for the predetermined source the risk level associated with each of the plurality of predetermined categories of sensitive content included in the sensitive content category data 207 for the particular user. The risk levels output by the risk analysis module 250 at the different levels of granularity may be stored in the datastore 205 as risk level data 210.

In some embodiments, the classification module 230 and the tonal model 240 may analyze metadata associated with the transcribed text data 206 in determining the presence of the different sensitive content categories and predicting the tonal fingerprint for the sensitive content categories whose presence is detected. For example, the brand integrity platform 110 may include machine learning models configured to detect objects, places and actions stored in the video and image content associated with the content corresponding to the transcribed text data 206. The pre-trained machine learning models may automatically recognize objects, places and actions in the video and image metadata. For example, the models may semantic segmentation to detect objects in a scene, including scene foregrounds and backgrounds, and further detect text in the images and videos, and convert the text into machine-readable text. The models may also analyze background noise, which could be music and any external audio and convert them to machine readable text. The models may support audio files in all languages and translated to English for further processing. Once the metadata is processed, the relevant contextual markers may be extracted and processed through the brand integrity pipeline where the risk levels for content safety and brand suitability are assessed. For example, features based on processed metadata may be input to the classification module 230 during the presence-of step analysis and input to the tonal model 240 to generate the tonal fingerprint. The output from the risk analysis module 250 may thus be further contextualized based on the metadata associated with the predetermined source.

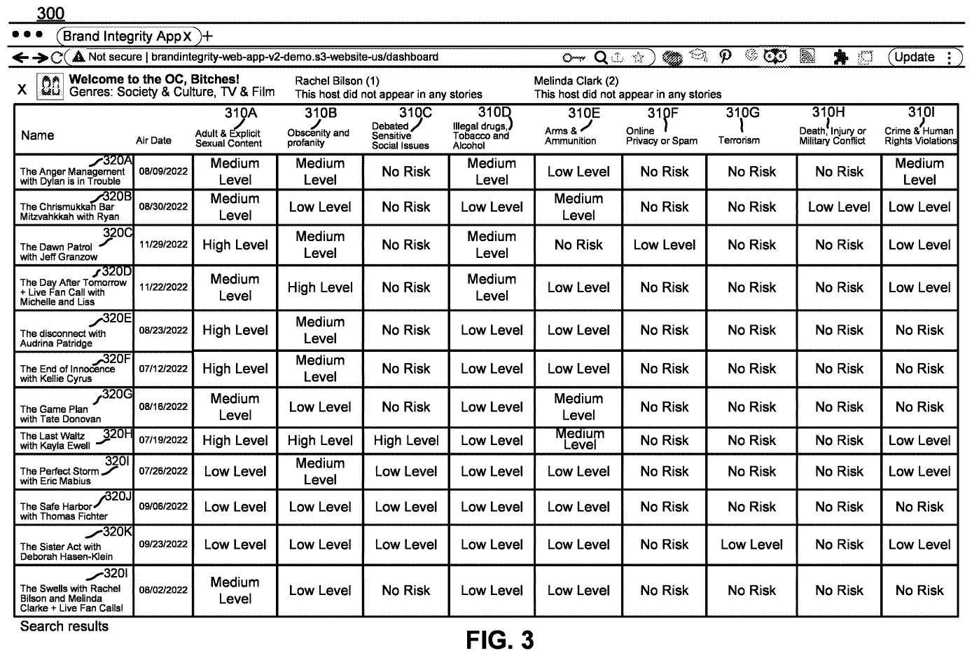

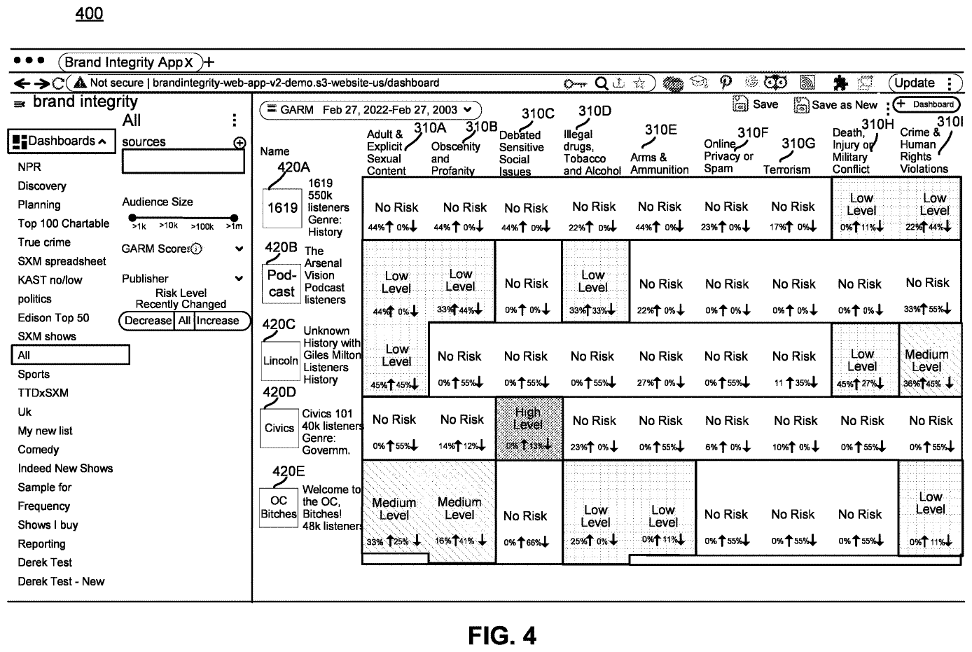

The interface module 255 is an interface for a user (e.g., advertiser) and/or a third-party software platform to interact with the brand integrity platform 110. The interface module 255 may be a web application that is run by a web browser on a user device or a software as a service platform that is accessible by a user device through a network (e.g., network 150 of FIG. 1). In some embodiments, the interface module 255 may use application program interfaces (APIs) to communicate with user devices or third-party platform servers (e.g., ad exchange 140 of FIG. 1, ad servers), which may include mechanisms such as webhooks. Example graphical user interfaces generated by the interface module 255 to enable interaction with the user are illustrated in FIGS. 3-4 described in detail below.

To enable each advertiser to selectively set their respective comfort levels for different (standardized or custom) sensitive content categories, the interface module 255 generates interfaces where an advertiser can selectively set their preferences for risk levels for different predetermined categories of sensitive content. These preferences may be stored in the datastore 205 as tolerance threshold data 211.

The action module 260 determines whether the risk level data 210 associated with the predetermined source of content meets the thresholds specified by the advertiser and stored in the datastore 205 as the tolerance threshold data 211. The action module 260 may perform one or more actions based on a result of the determination.

For example, for a particular podcast and for a given category of sensitive content, the action module 260 determines whether the risk level for the given category determined by the risk analysis module 250 is equal to or lower than the risk tolerance threshold set by a particular advertiser for the given category. The action module 260 makes similar determinations for each category of sensitive content for the particular podcast for which the risk analysis module 250 has determined a risk level and the particular advertiser has set a corresponding risk tolerance threshold.

If the risk level is equal or lower than the corresponding risk tolerance threshold for some or all of the sensitive content categories, the action module 260 may determine that the particular podcast meets the brand safety requirements specified by the advertiser. In some embodiments, the action module 260 may assign an affinity score based on the determination. The affinity score may be determined based on the number of categories where the risk level is equal or lower than the user specified threshold. The affinity score may further be determined based on a magnitude of the difference between the threshold and the determined risk level for the various categories, and the number of categories that are determined to be of no risk (i.e., no sensitive content detected by the classification module 230 in the presence-of step).

Based on the affinity scores for the different predetermined sources of content, the action module 260 may generate a ranked list of recommended content for ad placement. The level of granularity of the ranked list may be selectively settable by the user. For example, the action module 260 may generate ranked lists based on corresponding affinity scores at the episode-level for a given show, at a show-level across all shows from all publishers or a particular publisher, at a publisher-level for all shows of a given publisher, and the like.

The action performed by the action module 260 based on the determination may include indicating the particular podcast as a candidate that is recommended for an advertisement placement to the particular advertiser. As another example, based on the affinity score of a particular source of content, the action module 260 may perform an action of automatically transmitting an application programming interface (API) call to an advertisement server (e.g., ad exchange 140 in FIG. 1) to bid for an advertisement placement associated with the particular content (e.g., show or episode of a show). The interface module 255 may enable the advertiser to configure settings regarding automatically placing bids for ad placements via calls to the ad exchange's 140 API. For example, the advertiser may configure settings via the interface module 255 to set an affinity score cutoff for automatic API calls for ad placements. As another example, the advertiser may input via the interface module 255 to more nuanced settings for specific content categories that, when met by a given source of content based on calculated risk levels, results in the action module 260 automatically placing an ad buy request by making an API call (e.g., transmit API notification) to the appropriate ad server. In some embodiments, the interface module 255 may require user confirmation before transmitting the API call to the ad server.

The interface module 255 thus allows the users to interact with some or all of the ad inventory and their suitability scores in a dashboard environment. The action module 260 may use the same data (e.g., via API) to enforce the buying preferences in real-time in the ad exchanges.

By generating the risk level data 210 for all ad inventory and obtaining the granular and personalized tolerance threshold data 211 from individual advertisers, each advertiser on the brand integrity platform 110 can enforce their personalized brand suitability standards and ensure that their ads do not run alongside content they do not agree with (e.g., partisan content, gory content, adult content, etc.). By enabling each advertiser/brand to set their unique and nuanced profile in terms of their suitability preferences, the brand integrity platform 110 is able to ensure the custom preferences of each advertiser/brand enforced during the advertising purchase.

The host intelligence module 270 is configured to identify an entity associated with the predetermined source (e.g., the content source recommended as a candidate for ad placement by the action module 260) and obtain public sentiment scores for the entity over time. The scores output from the host intelligence module 270 may be stored in the datastore 205 as host intelligence data 212. In some embodiments, the action performed by the action module 260 based on, e.g., detecting an affinity score higher than an affinity score cutoff, is to present the public sentiment scores associated with the entity over time to the particular advertiser via the interface module 255. The entity associated with the predetermined source may be, e.g., the content creator, the host of the show or podcast, the producer, one or more actor, the performer, the record label, an organization associated with the entity and the like. Any entity that is associated with the content may be identified as the entity by the host intelligence module 270. The host intelligence module 270 may include a real-time news analysis pipeline for tracking sentiment about entities (e.g., podcast hosts), thereby allowing the user (e.g., advertiser) to understand public perception about the entity. The host intelligence module 270 may automatically aggregate news data that either mentions or references the entity of interest from publicly available news sources. The host intelligence module 270 may include a sentiment model to, e.g., obtain public sentiment (positive, negative, neutral) for each mention of the entity of the news data.

For example, for each mention of the entity in the news content, the host intelligence module 270 determines which part of the article (e.g., title, description, or content) mentions the entity. The host intelligence module 270 then uses coreference resolution to find all expressions that refer to a specific entity. To put it simply, it links all the pronouns to the referred entity. For example, using coreference resolution, the host intelligence module 270 can detect that mentions to “Obama”, “the president” and “he” could all refer to Barack Obama (i.e., the entity in this example). Based on the identified mentions in the article and the sentiment of each specific mention, the host intelligence module 270 is able to predict the overall sentiment expressed about the entity in the text. In some embodiments, the host intelligence module 270 uses a RoBERTa based sentiment model is for the sentiment analysis. The model also takes into consideration what part of the content the entity is discussed in (e.g., title, discussion, first 50% of the news content, etc.), and assigns scores to the detected sentiment accordingly. For example, the host intelligence module 270 may assign a higher coreference weight for entities that are being mentioned in title verse the description.

As another example, for entities that are being mentioned in the lower 25% of the article, the host intelligence module 270 may assign a lower weight compared to entities mentioned in the first 50% of the article content. The host intelligence module 270 may calculate a final component score for an article that mentions the entity of interest by aggregating the assigns scores for each mention in the article. For example, the host intelligence module 270 may calculate the sum of the products of the coreference weights times the sentiment score to determine the final component score. The host intelligence module 270 may further aggregate the final component scores for each article into daily scores (e.g., public sentiment scores) and related through a decay algorithm so that sentiment history is taken into account over time.

In some embodiments, the action module 260 may determine whether the public sentiment scores curved over time meet a predetermined condition. For example, the predetermined condition may be a recent negative public sentiment score greater than a threshold or for longer than a predetermined period of time. As another example, the predetermined condition may be a recent positive public sentiment score greater than a threshold or for longer than a predetermined period of time. If the predetermined condition is satisfied, the action module 260 may perform an action. For example, the action module 260 may be transmitting an API call to an advertisement server to bid for an advertisement placement associated with content corresponding to the public sentiment scores.

In some embodiments, the action module 260 may adjust or change the affinity scores for content based on the public sentiment scores over time for one or more entities associated with the content. For example, the action module 260 may lower an affinity score for podcast show if the content creator or host of the podcast show has a recent negative public sentiment score greater than a threshold or for longer than a predetermined period of time. The magnitude of the impact on the affinity score may be proportional to the magnitude of the negativity gleaned from the public sentiment scores over time output from the host intelligence module 270. The user may configure settings via the interface module 260 to adjust the weight of the public sentiment scores as they impact the affinity scores for content. In some embodiments, the action module 260 may simply present the public sentiment scores over time of the related entities for content as an additional datapoint for advertisers to consider when making ad buy decisions.

The topic model 275 is configured to accept as input the transcribed text data 206 and/or the metadata corresponding to the transcribed text data 206 to identify one or more of a plurality of tags associated with a taxonomy of content categories. The taxonomy of content categories may be standardized content taxonomy tags that can be utilized for driving contextually targeted ad placements. For example, the plurality of tags associated with the taxonomy of content categories may include the international advertising bureau (IAB) content taxonomy tags. The tags may also include tags that are customized or defined by the particular advertiser. The taxonomy of tags that are detectable in all content for a particular advertiser is stored as taxonomy data 213 in the datastore 205.

The topic model 275 may include a machine learning model that is trained by the model training engine 380 to accept features of the transcribed text data 206 and/or the metadata as input and extract topics that provide contextual understanding of the content corresponding to the transcribed text data 206. The ML model may use pretrained and finetuned Large language Models (LLM) to extract the topics.

The topic model 275 may further be configured to map the extracted topics representing the content to a standardized set of topics (e.g., IAB taxonomy tags) in order to facilitate contextual targeting. The topic model 275 may map the topics detected by the machine learned model as representing the text data 206 and/or related metadata to the taxonomy of tags stored as taxonomy data 213 by identifying tags in the taxonomy data 213 having a similarity to the topics higher than a threshold similarity (e.g., 75%) as the identified tags.

The topic model 275 may use prompt engineering on the LLM where it temporarily learns from the prompts and categorizes the text content with related taxonomy keywords. For example, the topic model 275 can categorize text content which is talking about crime and true crime with keywords from the IAB taxonomy such as “Crime” and “True Crime” based on the text analysis used within the content. The topic model 275 may aggregate the identified one or more of the plurality of tags across multiple instances of transcribed text associated with the predetermined source, and output the aggregated tags associated with the predetermined source (e.g., whole show or particular episode of a TV show or a podcast) to the user. The aggregated tags identified by the topic model 275 may be stored in the datastore 205 as tag data 214.

The action module 260 may present the tag data 214 as an additional datapoint for advertisers to consider when making ad buy decisions. The tag data 214 can be used to filter and identify content on the inventory dashboard generated by the interface module 255 to drive contextually targeted ad-buys (e.g., avoid podcasts that are tagged with the “Alcoholic Beverages” tag for an auto insurance company ad-buy). In some embodiments, the action module 260 may adjust or change the affinity scores for content based on the tag data 214. For example, the action module 260 may lower an affinity score for a podcast show if the show has been tagged with one or more of predetermined tags that have been pre-identified by the user. The magnitude of the impact on the affinity score may be proportional to the magnitude of the negativity associated with one or more of the tags pre-identified by the user. For example, the user may rate a particular tag at a high level on a sliding scale, and if such a tag is detected by the topic model 275 in connection with a given content source, the magnitude of the impact on the affinity score for the given content source will be high. As another example, the user may rate another tag at a medium level on the sliding scale, and if such a tag is detected by the topic model 275 in connection with the given content source, the magnitude of the impact on the affinity score for the given content source will be relatively lower. As another example, the action module 260 may determine whether the aggregated tags include a tag pre-identified by the user, and if so, remove the corresponding content source from a list of candidates for an advertisement placement, or otherwise indicate that the corresponding content source has a risk level that is higher than the threshold specified by the user. The topic model 275 thus extracts context from text data 206 and maps it to, e.g., the IAB taxonomy, to generate value by providing a solution for contextual advertising. The topic model 275 can analyze all ad inventory utterance by utterance and capture corresponding content taxonomy tags as the tag data 214. This allows for more granular targeting than just targeting by genre, publisher, tolerance thresholds for content categories, and the like.

The model training engine 280 trains machine-learned models of the brand integrity platform 110. The model training engine 280 accesses data for training the models stored in datastore 205 as model training data 215. The model training data 215 can include empirical text samples including text samples labeled to indicate presence of the predetermined category of sensitive content and text samples labeled to indicate absence of the predetermined category of sensitive content. Further, the model training data 215 can include empirical text samples including text samples labeled to indicate presence of one or more of a plurality of human emotions and a labeled score for each. Further, the model training data 215 can include empirical text samples and topics labeled as representing a summary to contextualize the text samples. Still further, the model training data 215 can include empirical text samples labeled with sentiments (e.g., positive, negative, neutral) expressed in the utterances captured as the text sample. The model training engine 280 may submit data for storage in training datastore 205 as model training data 215. The model training engine 280 may receive labeled training data from a user or automatically label training data (e.g., using computer vision). The model training engine 280 uses the labeled training data to train a machine-learned model. In some embodiments, the model training engine 280 uses user feedback to re-train the machine-learned models. The model training engine 280 may curate what training data to use to re-train a machine-learned model based on a measure of satisfaction provided in the user feedback. For example, the model training engine 280 receives user feedback indicating that a user is highly satisfied with the recommended content for ad placement or with the affinity scores or risk levels assigned to content. The model training engine 280 may then strengthen an association between features and a model output by creating training data using the features and machine-learned model outputs associated with the high satisfaction to re-train one or more of the machine-learned models. In some embodiments, the model training engine 280 attributes weights to training data sets or feature vectors. The model training engine 280 may modify the weights based on received user feedback and re-train the machine-learned models with the modified weights. By training a machine-learned model in a first stage using training data before receiving feedback and a second stage using training data as curated according to feedback, the model training engine 280 may train machine-learned models of the brand integrity platform 110 in multiple stages.

### Example Graphical User Interfaces Provided By The Brand Integrity System

FIGS. 3 and 4 are example illustrations of graphical user interfaces 300 and 400 provided by the brand integrity platform 110 for advertisers analyzing content for determining ad placements, in accordance with some embodiments.

Referring to FIG. 3, GUI 300 shows a dashboard that an advertiser to navigate to view the risk level data 210 determined by the risk analysis module 250 for each of a plurality of predetermined categories of sensitive content 310A-310I. In the example of FIG. 3, the GUI 300 displays the risk level data 210 for a podcast show “Welcome to the OC, Bitches!”. As shown in FIG. 3, the risk level data 210 is presented at an episode-level for a plurality of episodes 320A-320L with respective air dates. For a given sensitive content category, when the classification module 230 is unable to file the presence of keywords or topics associated with the category, the action module 260 may interact with the interface module 255 to display the “No Risk” label. When the classification module 230 detects the presence of keywords or topics associated with the category, the tonal model 240 may determine the tonal fingerprint based on the text data 206 (and/or related metadata) associated with the episode 320 for the category 310 and apply the corresponding score threshold data 209 for the category 310 to determine whether the content of the episode 320 poses “Low Level”, “Medium Level”, or “High Level” risk for the category 310, and presents that information in a color-coded tabular format as shown in FIG. 3.

By reviewing the information presented in FIG. 3, a brand may be able to easily and quickly identify content (e.g., episode 320H) that may not conform to desired risk levels for specific sensitive content categories and therefore, should be excluded from the ad inventory the brand wishes to bid on for ad placements.

Although not specifically shown in FIG. 3, the GUI 300 may also enable the brand to specify their preferred maximum risk levels for each category 310 (i.e., tolerance threshold data 211), and distinguishingly display episodes 320 that meet the brand-specified tolerance threshold data 211 for each category. In this case, the GUI 300 may also indicate an affinity score for each episode and a ranked list of episodes that meet the user's criteria.

FIG. 4 illustrates additional functionality that may be provided by the brand integrity platform 110 to advertisers. FIG. 4 presents the risk level data 210 at a “show-level” for each of the content categories 310A-310I and for each of a plurality of shows 410A-410E. GUI 400 further presents information describing a recent change in a risk level for a given show 410 for a given sensitive content category 310. For example, as new episodes are aired and analyzed by the risk analysis module 250 and correspond risk level data 210 generated, and aggregate risk level for the show 410 may change. This information regarding how the risk level for a show is trending in a given category may be beneficial to the advertiser in making ad placement decisions.

### Example Process For Determining A Risk Level For Content

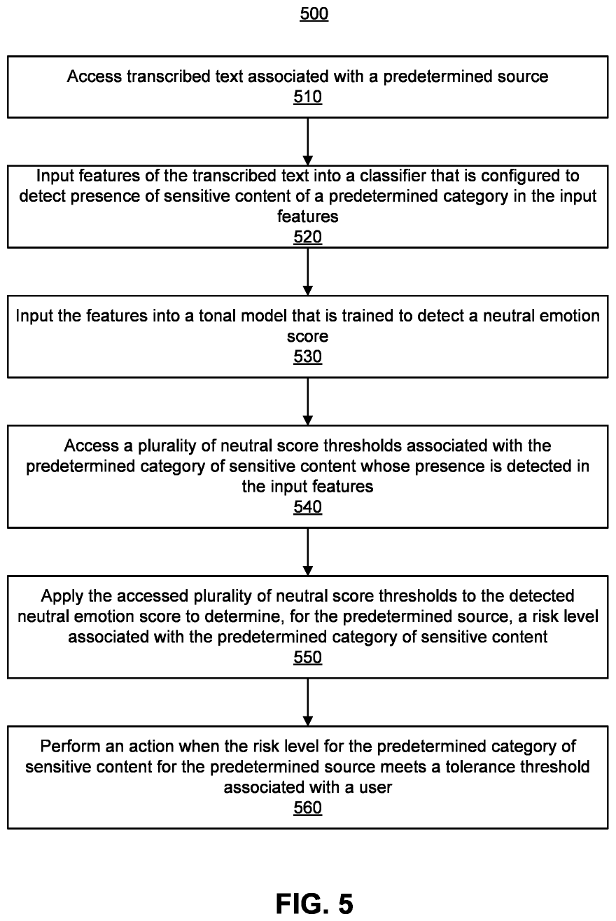

FIG. 5 is a flow chart illustrating a process 500 for determining a risk level for content, in accordance with some embodiments. It should be noted that the process illustrated herein can include fewer, different, or additional steps in other embodiments. Process 500 may be performed by the brand integrity platform 110.

The classification module 230 may access 510 transcribed text associated with a predetermined source. For example, the classification module 230 may access the transcribed text data 206 from the datastore 205 for a particular episode (e.g., one of 320A-320L) of a particular content source (e.g., show 410E). The classification module 230 may input 520 features of the transcribed text into a classifier (e.g., ML model 235) that detects presence of a predetermined category of sensitive content in the input features. For example, the classification module 230 may extract features from the transcribed text data 206 corresponding to a whole or a part of a particular episode of a particular show and input the features into a binary classification ML model to determine for a particular sensitive content category defined in the data 207 (e.g., one of the categories 310A-310I in FIGS. 3-4).

The tonal model 240 may input 530 the features extracted by the classification module 230 into a tonal model which is trained to detect a neutral emotion score (e.g., tonal fingerprint data 208).

The risk analysis module 250 may access 540 a plurality of neutral score thresholds (e.g., score threshold data 209) associated with the predetermined category of sensitive content (e.g., one of the categories 310A-310I in FIGS. 3-4) whose presence is detected in the input features at block 520 by the classification module 230. The risk analysis module 250 may apply 550 the accessed plurality of neutral score thresholds (e.g., score threshold data 209) to the detected neutral emotion score (e.g., tonal fingerprint data 208) to determine for the predetermined source (e.g., one of the plurality of episodes 320A-320L in FIG. 3) a risk level (e.g., low risk, medium risk, high risk) associated with the predetermined category of sensitive content (e.g., one of the categories 310A-310I in FIGS. 3-4).

The action module 260 may perform 560 an action (e.g., call the API of ad exchange 140 to place an automatic ad buy bid) in response to determining that the risk level for the predetermined category of sensitive content (e.g., risk level data 210 for one of the plurality of episodes 320A-320L and for one of the categories 310A-310I in FIG. 3) for the predetermined source meets a tolerance threshold (e.g., tolerance threshold data 211) associated with a user.

### Example Computer System

FIG. 6 is a block diagram illustrating components of an example machine for reading and executing instructions from a non-transitory machine-readable medium, in accordance with one or more example embodiments.

Specifically, FIG. 6 shows a diagrammatic representation of one or more of the brand integrity platform 110 of FIGS. 1 and 2, the publishers 120, the advertisers 130, and the ad exchange 140 of FIG. 1, and the machine for performing the process 500 of FIG. 5 in the example form of a computer system 600.

The computer system 600 can be used to execute instructions 624 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processing units (generally processor 602). The processor 602 is, for example, a central processing unit (CPU), a graphics processing unit (GPU), a digital signal processor (DSP), a control system, a state machine, one or more application specific integrated circuits (ASICs), one or more radio-frequency integrated circuits (RFICs), or any combination of these. The computer system 600 also includes a main memory 604. The computer system may include a storage unit 616. The processor 602, memory 604, and the storage unit 616 communicate via a bus 608.

In addition, the computer system 600 can include a static memory 606, a graphics display 610 (e.g., to drive a plasma display panel (PDP), a liquid crystal display (LCD), or a projector). The computer system 600 may also include an alphanumeric input device 612 (e.g., a keyboard), a cursor control device 617 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. For example, the instructions 624 may include the functionalities of modules of one or more of the brand integrity platform 110 of FIGS. 1 and 2, the publishers 120, the advertisers 130, and the ad exchange 140 of FIG. 1, and the machine for performing the process 500 of FIG. 5. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626 via the network interface device 620.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
accessing transcribed text associated with a predetermined source;
inputting features of the transcribed text into a classifier that is configured to detect presence of sensitive content of a predetermined category in the input features;
inputting the features into a tonal model that is trained to detect a neutral emotion score;
accessing a plurality of neutral score thresholds associated with the predetermined category of sensitive content whose presence is detected in the input features;
applying the accessed plurality of neutral score thresholds to the detected neutral emotion score to determine, for the predetermined source, a risk level associated with the predetermined category of sensitive content; and
performing an action when the risk level for the predetermined category of sensitive content for the predetermined source meets a tolerance threshold associated with a user.

2. The method of claim 1, wherein performing the action comprises:
transmitting an application programming interface notification to a digital item server to perform valuing for a digital item placement associated with the predetermined source.

3. The method of claim 1, wherein performing the action comprises:
recommending the predetermined source as a candidate for a digital item placement to the user.

4. The method of claim 1, further comprising:
identifying an entity associated with the predetermined source; and
obtaining public sentiment scores for the entity over time.

5. The method of claim 4, wherein performing the action comprises presenting the public sentiment scores over time to the user.

6. The method of claim 4, wherein performing the action comprises:
determining whether the public sentiment scores over time meet a predetermined condition; and
transmitting an application programming interface notification to a digital item server to perform valuing for a digital item placement associated with the predetermined source in response to the determination.

7. The method of claim 1, further comprising:
applying a topic model to the transcribed text to identify one or more of a plurality of tags associated with a taxonomy of content categories;
aggregating the identified one or more of the plurality of tags across multiple instances of transcribed text associated with the predetermined source; and
outputting the aggregated tags associated with the predetermined source to the user.

8. The method of claim 7, wherein performing the action comprises:
determining whether the aggregated tags include one or more tags specified by the user; and
removing the predetermined source from a list of candidates for a digital item placement.

9. The method of claim 7, wherein the topic model is configured to identify tags having a similarity to the transcribed text higher than a threshold similarity as the one or more of the plurality of tags.

10. The method of claim 1, wherein the predetermined source is content selected from a group including text content, audio content, and video content.

11. The method of claim 1, wherein the classifier is a first machine learning model that is trained based on empirical text samples including text samples labeled to indicate presence of the sensitive content of the predetermined category and text samples labeled to indicate absence of the sensitive content of the predetermined category.

12. The method of claim 1, wherein the tonal model is a second machine learning model trained based on empirical text samples including text samples labeled to indicate presence of one or more of a plurality of human emotions and a labeled score for each, one of the plurality of human emotions being a neutral emotion.

13. The method of claim 12, wherein the neutral emotion score is based on a predicted probability of the input features expressing the neutral emotion.

14. The method of claim 1, wherein the predetermined category of sensitive content is one of a plurality of predetermined categories of sensitive content, and wherein the classifier is one of a plurality of classifiers configured to respectively detect the presence of sensitive content of a corresponding one of the plurality of predetermined categories.

15. The method of claim 14, further comprising:
receiving, from the user at a user interface, input to selectively set a tolerance threshold for one or more of the plurality of predetermined categories of sensitive content;
wherein the action is performed when the risk level for each of the plurality of predetermined categories of sensitive content for the predetermined source meets respective tolerance thresholds selectively set by the user.

16. The method of claim 14, further comprising:
periodically redetermining for the predetermined source a risk level associated with each of the plurality of predetermined categories of sensitive content.

17. The method of claim 14, wherein at least some of the plurality of predetermined categories of sensitive content are custom categories defined by the user.

18. The method of claim 1, wherein the determined risk level is one of a low risk level, a medium risk level, and a high risk level.

19. A non-transitory computer-readable storage medium storing executable instructions that, when executed by a hardware processor of a brand integrity system, cause the hardware processor to perform steps comprising:
accessing transcribed text associated with a predetermined source;
inputting features of the transcribed text into a classifier that is configured to detect presence of sensitive content of a predetermined category in the input features;
inputting the features into a tonal model that is trained to detect a neutral emotion score;
accessing a plurality of neutral score thresholds associated with the predetermined category of sensitive content whose presence is detected in the input features;
applying the accessed plurality of neutral score thresholds to the detected neutral emotion score to determine, for the predetermined source, a risk level associated with the predetermined category of sensitive content; and
performing an action when the risk level for the predetermined category of sensitive content for the predetermined source meets a tolerance threshold associated with a user.

20. A brand integrity system, comprising:
a hardware processor; and
a non-transitory computer-readable storage medium storing executable instructions that,
when executed by the hardware processor, cause the hardware processor to perform steps comprising:
accessing transcribed text associated with a predetermined source;
inputting features of the transcribed text into a classifier that is configured to detect presence of sensitive content of a predetermined category in the input features;
inputting the features into a tonal model that is trained to detect a neutral emotion score;
accessing a plurality of neutral score thresholds associated with the predetermined category of sensitive content whose presence is detected in the input features;
applying the accessed plurality of neutral score thresholds to the detected neutral emotion score to determine, for the predetermined source, a risk level associated with the predetermined category of sensitive content; and
performing an action when the risk level for the predetermined category of sensitive content for the predetermined source meets a tolerance threshold associated with a user.
